(19) United States
(12) Patent Application Publication
(10) Pub. No.: US 2003/0050811 A1
(43) Pub. Date: Mar. 13, 2003

(54) System and method for hiring an applicant

(76) Inventors: Robert B. Freeman JR., Arlington, TX (US); Richard Logan Bilyea, Fort Worth, TX (US); Tirumala Kumar Kanakamedala, Plano, TX (US); Craig E. MacDonald, Dallas, TX (US); Deborah Y. Lollar, Arlington, TX (US)

Correspondence Address: J. Michael Martinez de Andino, HUNTON & WILLIAMS, Riverfront Plaza, East Tower, 951 East Byrd Street, Richmond, VA, 23219-4074, US

(21) Appl. No.: 09/949,566

(22) Filed: Sep. 10, 2001

(51) Int. Cl. G06F 17/60

(52) U.S. Cl. 705/7

(57) ABSTRACT

A method for hiring an applicant for a professional position is disclosed, comprising the steps of providing a hiring system, accessing the hiring system by the applicant, activating by the hiring system a first interface, accepting by the hiring system a first input from the applicant, storing the first input in an applicant record, activating by the hiring system a secondary interface, accepting by the hiring system a secondary input, storing by the hiring system the secondary input in the applicant record, utilizing by an administrator the hiring system to review the applicant record, determining by the administrator that the applicant satisfies professional job requirements necessary for hiring, giving by the administrator the applicant an offer, accepting by the hiring system acceptance input from the applicant, storing the acceptance input in the applicant record, and submitting by the hiring system the applicant record to a staffing system.

### FIELD OF THE INVENTION

The systems and methods of the invention relate to a system and method for hiring an applicant for a professional position.

### BACKGROUND OF THE INVENTION

In today's economy, business is done differently than it was in the past. Companies are constantly seeking new ways to attract new employees and get the most talented workers. Unfortunately, there is a large disconnect between many professionals seeking employment, and the businesses that need their service. With the growing familiarity of the Internet, many people have turned to the World Wide Web to find employment. Although the Web can provide many leads, few people are actually hired over the Web due to complications in various hiring processes. These complications may include the need for a candidate to interview at an office during inconvenient hours, travel far distances to a hiring center, for example. For some professions, the hardships of seeking professional employment weigh heavier on the individual professional.

Consider, for example, the professional nurse. Often, these men and women are juggling multiple demands in their careers, families, and lives, such that being able to search for alternative employment when it fits within their schedules becomes a priority. Illustratively, a registered nurse working two shifts consecutively, for ongoing periods of time, may not be able to search around for a position that requires her to work less for the same pay. The nurse needs a more flexible approach to search for other professional opportunities.

Accordingly, there is a need for an efficient Web-enabled hiring system that links professionals seeking jobs with employers needing their services. In addition, there is a need for an efficient application and hiring process accessible anytime and anyplace where Internet access is available. There is also a need for virtual offices for implementing the efficient application and hiring processes that are not tied to a physical presence in a particular geographic location.

### BRIEF SUMMARY OF THE INVENTION

In accordance with one embodiment, the invention provides a method for hiring an applicant for a professional position. The method first comprises the step of providing a hiring system, the hiring system including a user interface portion, the user interface portion accepting input from an applicant accessing the hiring system and displaying output generated by the hiring system. The method further includes the steps of the applicant applying for a professional position, providing for a processor portion for processing the input accepted by the user interface portion, providing for a memory portion, providing for the processing portion storing input accepted from the applicant in the memory portion, and providing for a management control portion, the management control portion for managing the applicant's status in the hiring system.

The method further includes accessing the hiring system by the applicant, activating by the hiring system a first input data entry interface, accepting by the hiring system a first input from the applicant using the first input data entry interface, the first input including basic applicant information, creating by the hiring system a new applicant data record in the memory portion and storing the first input in the new applicant data record.

The method also includes activating by the hiring system a secondary input data entry interface, accepting by the hiring system a secondary input from the applicant using the secondary input data entry interface, the secondary input relating to professional job requirements associated with the professional position applied for, storing by the hiring system the secondary input in the new applicant data record.

The method further comprises utilizing by a hiring system administrator the management control portion to review the new applicant data record, the new applicant data record including the first input and the secondary input submitted by the applicant, determining by the hiring system administrator that the applicant satisfies the professional job requirements necessary for hiring, and utilizing by the hiring system administrator the management control portion to give the applicant an offer for the professional position applied for.

Lastly, the method includes accepting by the hiring system acceptance input from the applicant of the offer for the professional position applied for and storing the acceptance input in the new applicant data record, and submitting by the hiring system the new applicant data record to an employee staffing system for assignment of the applicant to the professional position applied for.

In accordance with another embodiment, the method further includes the secondary input having at least professional license information and the system administrator begins verifying the professional license information upon receipt of the professional license information and before receipt by the hiring system of all required secondary input from the applicant.

In accordance with another embodiment, the method further includes the secondary input having at least professional reference information and the system administrator begins verifying the professional reference information upon receipt of the professional reference information and before receipt by the hiring system of all required secondary input from the applicant.

Also, a hiring system is disclosed in accordance with yet another embodiment of the invention. The hiring system comprising a user interface portion, the user interface portion accepting input from an applicant accessing the hiring system and displaying output from the hiring system, a processor portion for processing the input accepted by the user interface portion, a memory portion, the processing portion storing input received from the applicant in the memory portion, and a management control portion, the management control portion for managing the applicant's status in the hiring system.

The hiring system further provides for an applicant who accesses the hiring system through the user interface portion, the hiring system activates a first input data entry interface, the hiring system accepts a first input from the applicant using the first input data entry interface, the first input including basic applicant information, the hiring system creates a new applicant data record in the memory portion and stores the first input in the new applicant data record.

The hiring system activates a secondary input data entry interface, the hiring system accepts a secondary input from the applicant using the secondary input data entry interface, the secondary input relating to professional job requirements associated with the professional position applied for. The hiring system stores the secondary input in the new applicant data record, a hiring system administrator utilizes the management control portion to review the new applicant data record, the new applicant data record including the first input and the secondary input submitted by the applicant.

The hiring system administrator determines that the applicant satisfies the professional job requirements necessary for hiring, the hiring system administrator utilizes the management control portion to give the applicant an offer for the professional position applied for, the hiring system receives acceptance input from the applicant of the offer for the professional position applied for and stores the acceptance input in the new applicant data record, and the hiring system submits the new applicant data record to an employee staffing system for assignment of the applicant to the professional position applied for, for example.

### BRIEF DESCRIPTION OF THE DRAWINGS

The present invention can be more fully understood by reading the following detailed description of the presently preferred embodiments together with the accompanying drawings, in which like reference indicators are used to designate like elements, and in which:

FIGS. 1a and 1b are a flowchart showing a method of hiring an applicant for a professional position in accordance with one embodiment of the system and method of the invention;

FIG. 2 is a block diagram showing an illustrative hiring system in accordance with one embodiment of the system and method of the invention;

FIG. 3 is an illustrative management control portion interface in accordance with one embodiment of the system and method of the invention;

FIG. 4 shows the “Await further secondary input from Applicant” step of FIG. 1a in further detail in accordance with one embodiment of the system and method of the invention; and

FIG. 5 shows the “Await further secondary input from Applicant” step of FIG. 1b in further detail in accordance with one embodiment of the system and method of the invention.

### DETAILED DESCRIPTION OF THE INVENTION

In accordance with one embodiment, the invention provides a method for hiring an applicant for a professional position. The method comprises the steps of providing a hiring system, the hiring system including a user interface portion, the user interface portion accepting input from an applicant accessing the hiring system and displaying output generated by the hiring system, the applicant applying for a professional position providing for a processor portion for processing the input accepted by the user interface portion, a memory portion, the processing portion storing input accepted from the applicant in the memory portion, and providing for a management control portion, the management control portion for managing the applicant's status in the hiring system.

The method further includes accessing the hiring system by the applicant, activating by the hiring system a first input data entry interface, accepting by the hiring system a first input from the applicant using the first input data entry interface, the first input including basic applicant information, creating by the hiring system a new applicant data record in the memory portion and storing the first input in the new applicant data record.

The method also includes activating by the hiring system a secondary input data entry interface, accepting by the hiring system a secondary input from the applicant using the secondary input data entry interface, the secondary input relating to professional job requirements associated with the professional position applied for, storing by the hiring system the secondary input in the new applicant data record.

The method further comprises utilizing by a hiring system administrator the management control portion to review the new applicant data record, the new applicant data record including the first input and the secondary input submitted by the applicant, determining by the hiring system administrator that the applicant satisfies the professional job requirements necessary for hiring, utilizing by the hiring system administrator the management control portion to give the applicant an offer for the professional position applied for. The method additionally includes accepting by the hiring system acceptance input from the applicant of the offer for the professional position applied for and storing the acceptance input in the new applicant data record, and submitting by the hiring system the new applicant data record to an employee staffing system for assignment of the applicant to the professional position applied for.

Further details of the systems and methods of the invention will hereinafter be described. As used herein, items referred to in the singular may also be in the plural, and items referred to in the plural may also be in the singular.

As used herein, a “hiring system” may be a computer operating system that performs computational functions. The computational functions may be performed utilizing a suitable processor and memory stores, i.e. a data memory storage device, for example. The computational functions may include processing input and information from users of the hiring system, i.e. applicants and system administrators, to perform hiring process functions; processing input and information, as well as other data in the memory stores of the hiring system, to generate output on various interfaces with users of the hiring system; or outputting input or information gathered or produced by the hiring system to other systems, i.e. a staffing system, or a desired location, for example.

As used herein, a “profession” or “professional position” is any occupation or vocation requiring training in the liberal arts or the sciences and advanced study in a specialized field. This may include, but not be limited to, nurses, doctors, engineers, information technology professionals, computer programmers, accountants, airplane pilots, commercial vehicle operators, commercial vessel operators, lawyers, paralegals, and any other vocation or occupation that requires an individual to obtain a license or certification for practice within that profession.

Additionally, in accordance with one embodiment of the system and method of the invention, the hiring system may take the form a computer operating system managing a relational database. A relational database system allows information contained in different tables to be accessed and shared, while also providing the additional advantage that changes to data contained in one table of a relational database affects the same data in any other table sharing the same data. To provide further understanding, a table is a collection of several data records with similar data information fields. Data records represent a collection of data that is organized into fields. These fields may also be formatted to receive data of varying types such as alphanumeric, numeric or simple characters, for example. Accordingly, the database user can view data records in a user interface, input or edit the data contained in the various fields, or issue a database query that retrieves and reports information from multiple tables.

### METHOD FOR HIRING AN APPLICANT FOR A PROFESSIONAL POSITION

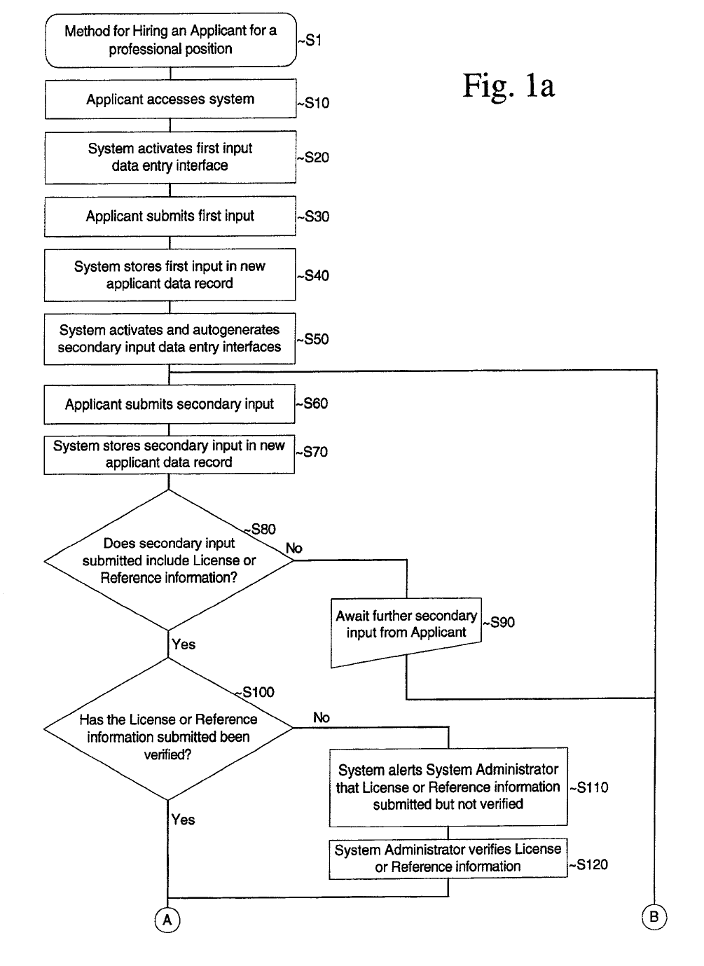

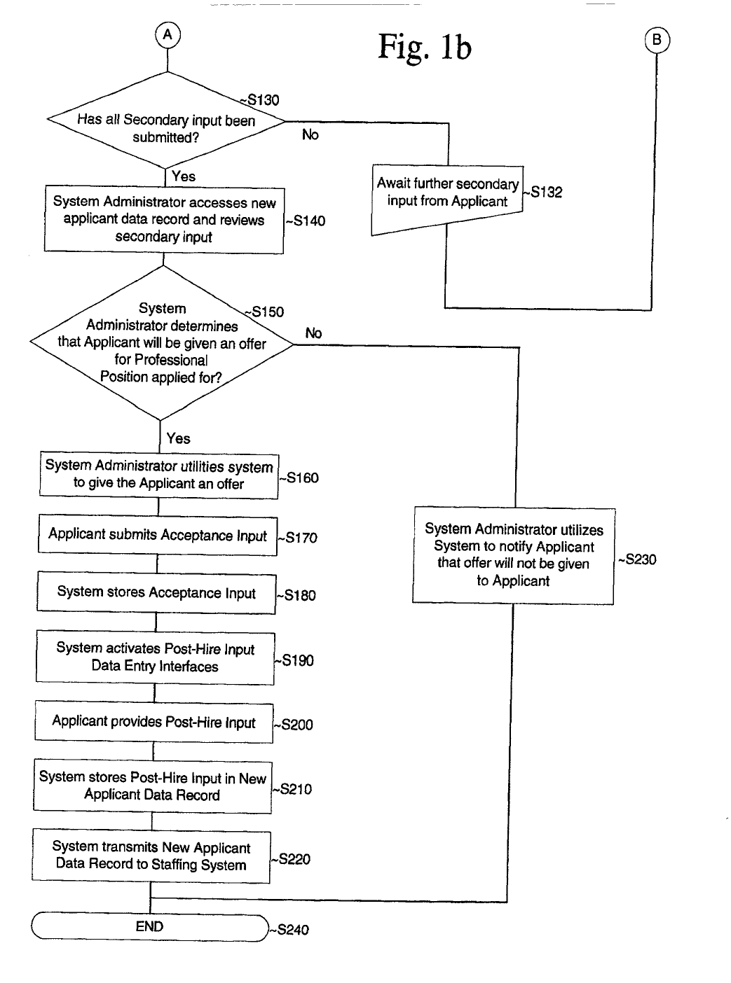

In accordance with one embodiment of the invention, an illustrative method of hiring an applicant for a professional position is shown in FIG. 1, and described below.

FIG. 1 is a flowchart showing a method of hiring an applicant for a professional position in accordance with one embodiment of the system and method of the invention. The process begins in step S1, and then passes to step S10, wherein an applicant accesses the hiring system.

The applicant can access the hiring system in any suitable manner which allows the user to provide input to the hiring system. Accordingly, any communication link established between the applicant and the hiring system is suitable. For example, the applicant may utilize a computer operating system to establish a connection to the Internet where she can view a web page linked to the hiring system. The applicant must then log on to the hiring system by providing an input that identifies the applicant, i.e. an applicant user name and an associated user name password. Once logged on, the system displays a user interface to the applicant.

First time applicants of the hiring system are required to register with the hiring system before they will be granted access. To register, an applicant may be required to provide such information as the applicant's name, desired profession or specialty, the applicant's full address, an e-mail address, an applicant user name and an associated user name password. It should be appreciated that the hiring system may create a unique e-mail account for each new applicant that registers with the hiring system. Furthermore, if a first time applicant does not provide an e-mail address, the hiring system may utilize the e-mail account created for the applicant and accessible by the applicant, as the applicant's e-mail address of record. The information submitted by the applicant to gain access to the hiring system is editable if the applicant submitted incorrect information. Once the information is submitted, however, the first time applicant is granted access to the hiring system with log on.

While the above example describes accessing the hiring system through the Internet, access to the hiring system may be achieved via any suitable communication interface, Internet connection, modem, telephone, digital or analog connections with the system using wireless communication devices, fax, or other computer connection, or any other suitable connection through which the hiring system's processor might receive input from an external source.

Returning to FIG. 1, once the applicant has accessed the hiring system, the hiring system activates the first input data entry interface in step S20. The applicant then submits her first input in step S30. In step S40, the hiring system stores the first input submitted by the applicant in a new applicant data record stored in a suitable memory device.

The hiring system, as stated above, may take the form a computer operating system managing a relational database. Therefore, in one embodiment of the invention, the new applicant data record may be a record contained in a table of active candidate records. This active candidate record table can be stored in the memory portion of the hiring system, thus allowing an applicant to access her individual new applicant data record when logging on. The new applicant data record records the progress of the applicant in the hiring system, and the processor portion directs the user interface portion to prompt the applicant to provide the next input whenever the applicant enters the hiring system. This allows the applicant to sign off the system, and return later, wherein the applicant's progress in the process is marked by the new applicant data record associated with the applicant.

It should also be appreciated that the first input data entry interface, and the secondary input data entry interfaces described below, may be presented in the user interface portion in any suitable manner that allows the applicant to submit input to the hiring system. An electronic data entry form where an applicant can utilize a user interface to make a selection or provide input to the hiring system is one example. It is also understood that upon access to the hiring system, the user interface portion may present the applicant with a list of links, or expanded list of links, to the various input data entry interfaces. The applicant can select an active link, go to the selected interface and provide the input requested in that interface.

While the user interface portion allows the applicant to provide input to the hiring system, the management control portion allows the prospective employer to review the information submitted by the applicant in the hiring process. The management control portion provides the interface between a system administrator and the hiring system. A system administrator may be a hiring manager, staffing manager, human resources employee, for example. Essentially, the system administrator, the individual who can access the hiring system through the management control portion, may be anyone with responsibilities and duties associated with hiring prospective employees, involved in the prescreening or hiring processes.

The hiring system may also be managed by a team of system administrators. Each individual system administrator would be responsible for monitoring the progress of applicants assigned to her as they progress through the hiring process. Accordingly, at any point throughout the hiring process, up to the point where a hiring decision is made, the applicant may be assigned to a given system administrator. Once assigned to a system administrator, the applicant is given the assigned system administrator's contact information. This information may be sent through an e-mail to the applicant's e-mail address of record and may be available in the applicant's user interface. The utilization of the management control portion by the system administrator to manage the applicant's progress in the hiring system is described in detail below.

In step S30, the applicant utilizes the first input data entry interface to submit personal information regarding the applicant. The first input data entry interface is the applicant's gateway to the hiring process and the hiring system. Once the applicant submits the first input, the hiring system creates a new applicant data record for the applicant, in which the first input is stored. The applicant cannot proceed in the hiring process until the first input is submitted. Furthermore, the first input data entry interface may request several pieces of information, although some may be required and others may be optional.

Illustratively, the first input may include, but not be limited to, statements about the applicant's amount of experience related to the professional position applied for, a professional employment classification indicating the profession the applicant is seeking employment within (i.e. registered nurse, paralegal, engineer), a primary position or specialty selection indicating the sub-section of the profession the applicant desires employment within (i.e. pediatrics for the registered nurse, litigation for the paralegal, civil engineering for the engineer), the applicant's name, preferred name, Social Security number, the applicant's address, the applicant's phone number(s) (i.e. home, work, wireless, pager), the applicant's e-mail address, information on how the applicant discovered the hiring system (including referrals), the applicant's drivers license, whether or not the application has reliable transportation, and whether the applicant has previously been employed under the hiring system, for example. If the applicant provides an e-mail address, the e-mail address becomes the applicant's e-mail of record and all e-mail correspondence sent through the hiring system to the applicant is sent there. If the applicant does not provide an e-mail address, the hiring system may create an e-mail account for the applicant to receive e-mail from the hiring system. Accordingly, the hiring system may be setup such that once the applicant has provided the first input, a welcome e-mail is sent to the applicant's e-mail of record welcoming the applicant to the hiring process.

In one embodiment of the invention, the information requested in the first input data entry interface may be auto-populated with information submitted by the applicant during registering with the hiring system. In this embodiment, the information submitted upon registration may be placed in the corresponding fields, and may be edited by the applicant before final submission to the hiring system. Accordingly, the applicant can alter or amend information given at register that may have been incorrect.

Once the first input is stored by the hiring system, in step S50, the secondary input data entry interfaces are auto generated and activated. The applicant submits secondary input to the hiring system in step S60. The process then passes to step S70 wherein the hiring system stores the secondary input submitted by the applicant in the new applicant data record.

Similar to the first input data entry interface, the secondary input data entry interfaces allow the applicant to submit information about the applicant relating to the professional job requirements of the professional position the applicant is applying for, i.e. secondary input. For example, the secondary input may include, but not be limited to, professional information (i.e. professional licenses and certifications), the applicant's work history, skills and certifications, answers to supplemental questions, acknowledgement of the employer's equal opportunity policy and information on the applicant's sex and race, a skills inventory (i.e. test based on professional position applied for, and possibly, location applied for), and an acknowledgement of the hiring system's policy including a statement that all input submitted by the applicant is true and accurate.

In one embodiment of the invention, there is a secondary input data interface associated with each of the above-described secondary inputs. These secondary input data interfaces may be provided as electronic forms containing fields through which the applicant can submit the requested input or information. The first input data entry interface may be provided in a similar fashion, i.e. as an electronic form containing fields associated with the information requested.

For example, professional information includes information such as license or certification information, educational background and professional references. Therefore, the interface may request input such as the applicant's license classification, state, license number, expiration date, whether the applicant's license or certification has ever been investigated or had disciplinary action taken against it, whether the applicant's license or certification is currently being investigated or having disciplinary action taken against it, educational institutional attended, degrees awarded, and professional references from others in the profession that the applicant is seeking employment within. The professional information interface may also request that the applicant give the system administrator permission to contact the applicant's references and verify the applicant's license or certification information.

The secondary input data interface associated with the applicant's work history may request the applicant's current and past employer's names, addresses, phone numbers, and any other information related to the applicant's work history with those employers. This information may further include the applicant's supervisor at each place of employment, along with the supervisor's contact information. The applicant may also be asked to explain any gaps of employment. Also, the applicant will be asked to give the system administrator permission to contact the applicant's past and current employers to verify the applicant's work history.

The secondary input data interface associated with the skills and certification input may request various applicant information regarding areas of experience and/or skills acquired. Consider, for example, an applicant applying for a registered nurse position. The interface may then require the applicant to state whether she has experience in such areas as bums, CCU, doctor's offices, dialysis, emergency room, AIDS, homecare, ICU, nursing home, pediatrics, and other specialties within the nursing profession, for example. Certifications may include CPR, ACLS, PALS, NALS, CEN, or other nursing certifications.

The supplemental questions interface is based upon the professional position the applicant is applying for, the specialty within the professional position, and the applicant's desired place of employment. Such questions may be state specific. The supplemental questions may require the applicant to state whether or not she is qualified under the Americans With Disabilities Act, statements about the applicant's illegal drug use, or whether the applicant has ever been convicted of a crime. The equal employment interface displays the nondiscrimination statement of the hiring system as well as providing a form where the applicant can provide voluntary compliance data.

The secondary input data interface associated with the skills inventory provides a test that each applicant is required to pass, the test being determined by the professional position and specialty for which the applicant is applying. Test questions are provided in multiple choice form, and after finishing the test, the applicant is allowed to review her answers before submitting the test for grading. The skills inventory interface may also provide a history of the applicant's test taking including whether or not the applicant has taken a test, the applicant's score on the test, the date the test was taken, and other test information.

In one embodiment of the invention, the secondary input data entry interfaces may be auto generated by the hiring system in response to the applicant's first input. In particular, secondary input data entry interfaces associated with the supplemental questions and skills inventories may be affected by the applicant's professional employment classification chosen in the first input data entry interface, as well as the desired location of employment selected by the applicant. For example, if an applicant seeking a registered nurse position chooses to apply for a position in Alabama, the secondary input data entry interface related to supplemental questions may hypothetically require the applicant to certify that she has never been convicted of a felony. Similarly, the secondary input data entry interface related to skills inventories may require the applicant to answer questions related to certification of registered nurses in Alabama. However, it should be appreciated that any secondary input data entry interface requiring applicant information related to the professional job requirements associated with the professional position applied for may be tailored to the applicant's first input submitted to the hiring system.

The hiring system, in step S80, then determines if the secondary input submitted by the applicant and stored in the new applicant data record includes license or reference information. If the secondary input submitted does include license or reference information, the process passes to step S100, wherein the hiring system determines if the license or reference information submitted has been verified. When the applicant submits the license or reference information, the hiring system may require the applicant to give a system administrator permission to verify this information.

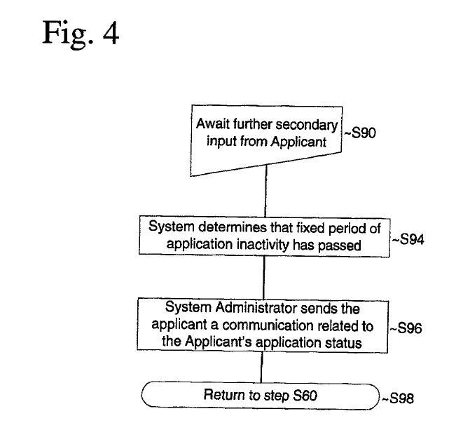

However, if in step S80, the system determines that the secondary input received by the hiring system from the applicant does not include license or reference information, the process passes to step S90, wherein the hiring system awaits the receipt of further secondary input from the applicant. As shown in FIG. 4, the system administrator may utilize the hiring system to keep in contact with the applicant during periods of applicant inactivity, i.e. a lack of secondary input from the applicant when the applicant has not completed the hiring process.

FIG. 4 shows the “Await further secondary input from Applicant” step of FIG. 1a in further detail in accordance with one embodiment of the system and method of the invention. While the hiring system is awaiting further secondary input from the applicant, in step S94, the hiring system determines that a fixed period of applicant inactivity has passed. After the applicant has submitted the first input, a fixed period of application inactivity may include any amount of time over which the applicant has not submitted any further input to the hiring system, or otherwise contacted a system administrator. This period of time may be set as desired by the skilled artisan depending on the hiring system's utilization. Once the hiring system determines that the fixed period of applicant inactivity has passed, for the given applicant, the system administrator may be notified. Consequently, in step S96, the system administrator sends the applicant a communication related to the applicant's application status in the hiring system. This communication essentially notifies the applicant of her current status, and may seek to offer advice or provide counseling directed at getting the applicant to complete the application process by submitting all required secondary input. Once the communication has been sent, the process awaits further secondary input from the applicant, upon which, in step S98, the process returns to step S60.

Returning to FIGS. 1a and 1b, the hiring method and system do not require that all of the secondary input requested in the secondary input data entry interfaces be submitted at one time. This information may be submitted over a period of time, and once all secondary input has been submitted, the system administrator assigned to the applicant can make a hiring decision regarding the applicant. As described above, the new applicant data record tracks the applicant's progress in the hiring process, and stores the submitted input such that the applicant can return to the hiring system several times before completing the application process.

If in step S100, the hiring system determines that the license or reference information submitted by the applicant has not been verified, the process passes to step S110, wherein the hiring system displays to the system administrator that the applicant has submitted secondary input including license or reference information, but that information submitted has not been verified. This may include posting a new applicant event associated with the applicant's new applicant data record such that the system administrator can review the information in a suitable interface. Consequently, the system administrator, in step S120, verifies the license or reference information submitted that had not been previously verified.

Accordingly, once the system administrator reviews the new applicant data record, and determines that either the license or reference information has been submitted for verification, the system administrator can begin steps to verify that information. Given that secondary input can be submitted to the hiring system over a period of time, and the process of verifying an applicant's licenses or references constitutes a large time-consuming activity for the system administrator, once the license or reference information is submitted, the system administrator preferably begins to verify this information. Due to the importance of this verification, an offer cannot be made to an applicant until this input is verified. Thus, the sooner this information is verified, the faster the hiring process operates.

Indeed, after the license or reference information is verified, the system administrator confirms this in the new applicant data record. It should also be appreciated that once the license or reference information is verified and confirmed in the new applicant data record, the related secondary input data interface is complete, and the hiring system awaits further secondary input from the applicant.

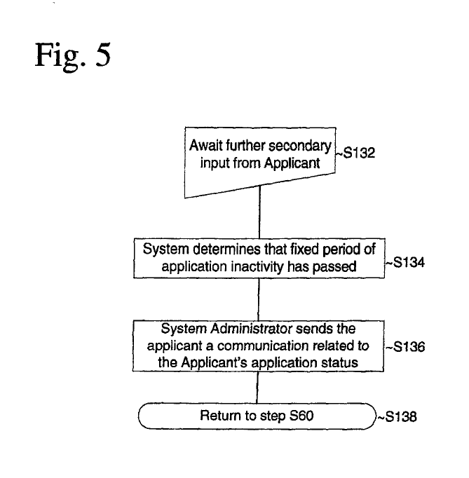

However, if in step S100, the hiring system determines that the license or reference information submitted by the applicant has been verified, the process passes to step S130, wherein the hiring system determines if all secondary input has been submitted by the applicant. If all secondary input has not been submitted by the applicant, the process passes to step S132, wherein the hiring system awaits further secondary input from the applicant. As shown in FIG. 5, the system administrator may utilize the hiring system to keep in contact with the applicant during periods of applicant inactivity, i.e. a lack of secondary input from the applicant when the applicant has not completed the hiring process.

FIG. 5 shows the “Await further secondary input from Applicant” step of FIG. 1b in further detail in accordance with one embodiment of the system and method of the invention. While the hiring system is awaiting further secondary input from the applicant, in step S134, the hiring system determines that a fixed period of applicant inactivity has passed. After the applicant has submitted the first input, a fixed period of application inactivity may include any amount of time over which the applicant has not submitted any further input to the hiring system, or otherwise contacted a system administrator. This period of time may be set as desired by the skilled artisan depending on the hiring system's utilization. Once the hiring system determines that the fixed period of applicant inactivity has passed, for the given applicant, the system administrator may be notified. Consequently, in step S136, the system administrator sends the applicant a communication related to the applicant's application status in the hiring system. This communication essentially notifies the applicant of her current status, and may seek to offer advice or provide counseling directed at getting the applicant to complete the application process by submitting all required secondary input. Once the communication has been sent, the process awaits further secondary input from the applicant, upon which, in step S138, the process returns to step S60.

Returning to FIGS. 1a and 1b, if in step S130 the hiring system determines that all of the secondary input has been received, the process passes to step S140. In step S140, the system administrator accesses the new applicant data record and reviews the secondary input submitted by the applicant. Then, in step S150, the system administrator determines whether the applicant will be given an offer for the professional position applied for.

The hiring determination may rest on a number of factors, depending on the position applied for. Given that the secondary inputs relate to the professional job requirements associated with the position applied for, the system administrator must determine if the applicant's inputs meet established hiring standards. For example, consider the applicant seeking employment as a registered nurse in Alabama. Hypothetically, if Alabama state law requires that registered nurses cannot have been convicted of a felony, and the applicant replies to a supplemental questions stating that she was once convicted of a drug felony, the applicant would clearly not meet the hiring standards for the position sought. Furthermore, if the same applicant, without the felony conviction, incorrectly answered a set number of questions in the skills inventory related to registered nurse certifications in Alabama, the applicant has again not met hiring standards. Of course, the hiring system may offer the applicant the opportunity to review incorrect answers with instruction, and the chance to complete a make-up skills inventory, for example. Consequently, individual hiring requirements implemented and examined in the hiring method and system may be crafted as desired by the skilled artisan based on the professional positions being screened.

If the system administrator determines that the applicant will be given an offer, the process passes to step S160, wherein the system administrator utilizes the hiring system to give the applicant the offer. When the offer is given, the hiring system also records the offer as a new applicant event. Next, in step S170, the applicant submits acceptance input to the system. Then, the hiring system stores the acceptance input in the new applicant data record in step S180. It should be appreciated that the system administrator may have to review the applicant's acceptance input before the acceptance input can be recorded in the new applicant data record indicating that the applicant has accepted the position offered. The process then passes to step S190, wherein the hiring system activates the post-hire input data entry interfaces.

The post-hire data entry interfaces may include, but not be limited to, hiring information, including the applicant's desired method of payment (i.e. hard check, direct deposit), the applicant's desired withholding allowance and associated federal tax forms (i.e. W-4), the applicant's employment eligibility and associated federal forms (i.e. I-9), an emergency contact for the applicant, and professional position related employee health certifications (i.e. Hepatitis B vaccination for registered nurses). The post-hire data entry interfaces may further include orientation information that the applicant must certify has been reviewed before the applicant will be assigned to the professional position hired. This orientation information may include various orientation presentations, an employee handbook, standards of business conduct, professional position related required presentations, and state specific required presentations, for example.

The applicant then provides the post-hire input in step S200. Once the post-hire input has been submitted by the applicant, the hiring system stores the post-hire input in the new applicant data record in step S210. The hiring system then, in step S220, transmits the new applicant data record to a staffing system. The process then passes to step S240. In step S240, the process ends.

It should be appreciated that even thought the applicant may submit all required post-hire input through an established communication link to the hiring system, the applicant may be required to visit an associated employee office for verification of employee eligibility in conformity with federal laws.

Alternatively, if in step S150, the system administrator determines that the applicant will not be given an offer, the process passes to step S230, wherein the system administrator utilizes the hiring system to notify the applicant that she will not be given an offer for the position applied for. The process then passes from step S230 to step S240. In step S240, the process ends.

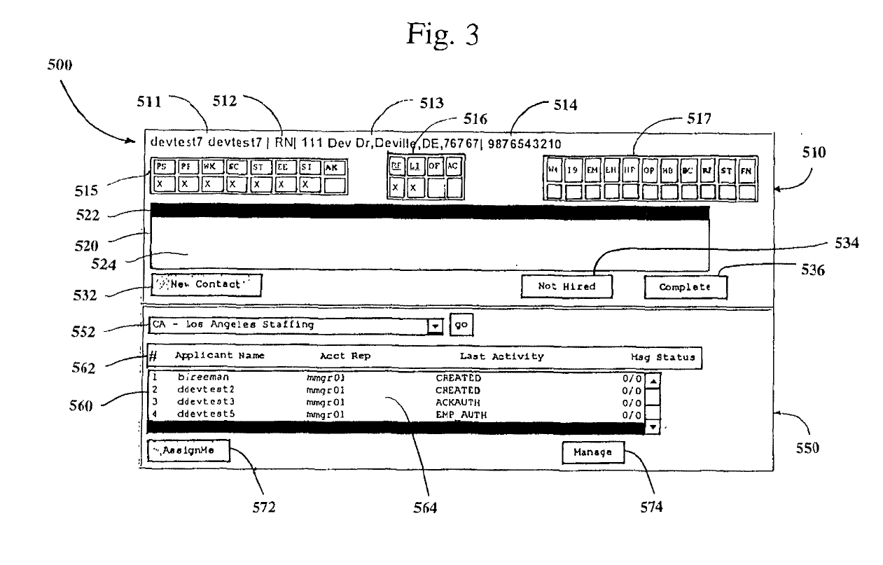

In accordance with one embodiment of the system and method of the invention, as stated above, the hiring system may include a computer operating system managing a relational database. In addition, as stated above, the management control portion provides the interface between the system administrator and the hiring system, allowing the system administrator to screen the applicant during the hiring process. Therefore, it should be appreciated that since the applicant and system administrator provide input and review output of the hiring system using different interfaces with the hiring system, input submitted in one interface affects the output displayed in the other interface. To provide further understanding of this aspect of this embodiment of the invention, FIG. 3 is described in detail below.

FIG. 3 is an illustrative management control portion interface with the hiring system in accordance with one embodiment of the system and method of the invention. The management control portion interface 500 includes an applicant data record portion 510 and an active candidates portion 550. As shown in FIG. 3, the applicant data record portion 510 displays fields containing specific information regarding the applicant selected in the active candidates portion 550. The specific applicant displayed in the applicant data record portion 510 either may include input or information submitted by the applicant, or a link to input or information submitted by the applicant. For example, name field 511 contains the selected applicant's name. Profession field 512 contains an abbreviation for the professional position the selected applicant has applied for. The “RN” in profession field 512 denotes that the selected applicant is seeking employment as a registered nurse. Furthermore, address field 513 contains the applicant's address, and phone number field 514 contains the applicant's contact telephone number.

The applicant data record portion 510 also contains fields that provide links to other input and information submitted by the applicant. For example, first/secondary input field 515 can contain several active links that when selected, display the input or information submitted by the applicant as denoted by the abbreviation associated with each link. In this embodiment, examples of such action links include, but are not limited to, “PS” for personal information; “PR” for professional information (i.e. license, certification, education or other professional material); “WK” for work references; “SC” for skills certification; “ST” for state specific questions; “SQ” for supplemental questions; “EE” for equal employment statement; “SI” for skills inventory; “AK” for acknowledgement. In addition, each link in first/secondary input field 515 may have an associated sub-field that tracks the applicant's status with respect to the input or information associated with each link. As shown in FIG. 3, these sub-fields are represented as a box below each link, and contain either an “X” denoting that the applicant has completed the requested input, or “P” denoting that the applicant is in progress and has not completed the requested input.

The applicant data record portion 510 also includes a hiring field 516 that displays information about the hiring decision made regarding the applicant, and provides active links to verification interfaces utilized by the system administrator to verify the information submitted by the applicant including licenses, certifications, education, and work experience and references. For example, “RF” denotes a link to the work history or reference input submitted by the applicant and provides and interface whereby the system administrator can confirm that the information has been checked. Similarly, “LI” denotes a link to the professional information, or licensure, input submitted by the applicant and provides and interface whereby the system administrator can confirm that the information has been checked.

The hiring field 516 also displays information related to whether or not the selected applicant has been given an offer, and if given an offer, whether she has accepted the offer. As shown in FIG. 3, an “X” in the sub-field below “OF” denotes that the applicant has been given an offer, and an “X” in the sub-field below “AC” denotes that the applicant has accepted the offer given.

The applicant data record portion 510 also includes a post-hire input field 517 that contains several active links that when selected, display the input or information submitted by the applicant as denoted by the abbreviation associated with each link. In this embodiment, “W4” denotes W-4 information; “I9” denotes I-9 information; “EM” denotes emergency contact; “EH” denotes employee health statement; “HP” denotes Hepatitis B Vaccination Acceptance Declination; “OP” denotes orientation presentation; “BC” denotes the employer's Standards of Business Conduct; “RP” denotes required presentations; “ST” denotes state specific documents required by law; and “FN” denotes finishing up. In addition, each link in post-hire input field 517 may have an associated sub-field that tracks the applicant's status with respect to the input or information associated with each link. As shown in FIG. 3, these sub-fields are represented as a box below each link, and contain either an “X” denoting that the applicant has completed the requested input or reviewed the linked material, or “P” denoting that the applicant is in progress and has not completed the requested input.

In accordance with one embodiment of the system and method of the invention, the links provided in the first/secondary input field 515 will not become active until there is an “X” in the sub-field associated with “PS”, denoting that the applicant has submitted her first input, i.e. the applicant's personal information. The “RF” link in hiring field 516 will not become active until there is an “X” in the sub-field associated with “PR” in the first/secondary input field 515. Similarly, the “LI” link in hiring field 516 will not become active until there is an “X” in the sub-field associated with “WK” in the first/secondary input field 515. Also, the links provided in the post-hire input field 517 will not become active until there is an “X” in the sub-field associated with “AC” in the hiring field 516, denoting that the applicant has accepted the position offered.

The applicant data record portion 510 also includes an event log 520 having a heading portion 522 and a communication portion 524. The heading portion 522 divides the displayed area of the event log 520 into different fields which may include events, subject, message, and date, for example. The communication portion 524 lists all communications, or applicant events, between the applicant and the assigned system administrator that are sent to or through the hiring system, and other contacts between the applicant and system administrators in the hiring system. An applicant event may include an e-mail to the applicant, an e-mail from the applicant, a telephone call to or from the applicant, an in person meeting with the applicant, a voicemail for or from the applicant, an offer or an acceptance. For example, an event may be a welcome e-mail sent from the system administrator to the applicant, or a record of a phone call from the applicant to the system administrator inquiring about a certification issue. Selecting an item in the event log 520 opens a non-editable full copy of the item.

It should be appreciated that when the applicant begins the hiring process, an e-mail account unique to the applicant is created. Thus, by sending e-mail to that unique account, the e-mail communication is delivered to the event log for the applicant, and recorded in the applicant's record.

The applicant data record portion 510 also includes several buttons which affect data in the hiring system. The new contact button 532 allows the system administrator to contact the highlighted applicant through the hiring system. For example, the system administrator can use the new contact button 532 to send the applicant an e-mail to the applicant's e-mail address of record. The system administrator may also use the new contact button 532 to send the applicant a reminder e-mail when the applicant has completed a portion of the hiring process, but has not submitted all required input. Similarly, the hiring system may also deliver a reminder e-mail to the system administrator or the applicant once a period of inactivity on the applicant's part resulting in an incomplete application occurs. The new contact button 532 also records each new contact with the applicant in the event log 520.

The not hired button 534 removes the selected applicant from the active candidates portion 550, which precludes the applicant from proceeding any further in the hiring system, and sends the applicant an e-mail notifying her of her removal from the hiring system. The complete button 536 removes the selected applicant from the active candidates portion 550, and transfers the applicant's record to a staffing system for assignment of the applicant to the position accepted.

As stated above, the illustrative interface 500 also includes an active candidates portion 550. The active candidates portion 550 allows the system administrator to sort through the pool of active applicants in the hiring process, based on the applicants' desired employment location. It should be appreciated that the active candidates portion 550 may include other devices for sorting the pool of applicants, including sorting by desired profession, specialty, or any other input asked of the applicants, for example.

In this embodiment, the active candidates portion 550 includes a location sorting tool 552, an active candidate log 560 having a heading portion 562 and a candidate list portion 564, an assignment button 572, and a manage button 574. The location sorting tool 552 allows the system administrator to sort through active applicants in the hiring process based on the desired location each has selected for prospective employment. The active candidate log 560 displays to the system administrator all active applicants for the location selected. The heading portion 562 divides the displayed area of the active candidate log 560 into different fields including applicant number, applicant name, system administrator (i.e. which system administrator the applicant has been assigned to), applicant status, and last activity (i.e. the last activity completed by the applicant or system administrator in the hiring process), for example. The candidate list portion 564 displays a number of applicant records and the information corresponding to the fields established in the heading portion 562.

The assignment button 572 is utilized by the system administrator to assign an applicant to a particular system administrator. In this respect, once assigned, the system administrator is responsible for managing the applicant through the hiring process. In addition, once assigned, the e-mail account provided to the applicant at the beginning of the hiring process delivers the applicant's communications to the assigned system administrator through the hiring system. The manage button 574 simply allows the system administrator to select and review an applicant highlighted in the active candidate log 560. It should be appreciated that the same function performed by the manage button 574, i.e. displaying the selected applicant in the applicant data record portion 510, may be accomplished by double-clicking on the applicant in the candidate list portion 564.

As the management control portion interface 500 has been described above, in the context of the hiring system, it should be appreciated that inputs and information from the applicant relationally affect the applicant's record in the hiring system, as displayed in the management control portion interface 500.

Illustratively, in the embodiments described above, when in step S40 the system stores the first input submitted by the applicant in a new applicant data record stored in a suitable memory device, the new applicant data record appears in the active candidate log 560. Furthermore, an “X” is shown in the sub-field associated with “PS” in the first/secondary input field 515, as well as “PS” becomes an active link to the information submitted by the applicant.

In addition, when in step S60 the applicant submits secondary input, an “X” is placed in the sub-field associated with the type of secondary input submitted, i.e. “PR”, “WK”, or others displayed in first/secondary input field 515. Next, when in step S80, the hiring system determines that the applicant has submitted license or reference information, the “LI” or “RF” in the hiring field 516 become active links to information verification pages for use by the system administrator for verifying and recording the applicant's information. Once the information is verified in step S120, an “X” appears in the sub-field associated with the verified type of secondary input. Similarly, when in step S160, the applicant is given an offer, and “X” is shown in the sub-field associated with “OF” in the hiring field 516. Once the applicant accepts the offer in step S170, an “X” is shown in the sub-field associated with “AC” in the hiring field 516. Finally, the transmission of the new applicant data record to a staffing system in step S220 may be effectuated by the system administrator selecting the complete button 536.

It should be appreciated that the above-described examples of the relational effects of inputs to the hiring system as shown in the management control portion interface 500 are not exclusive, and other relational effects may be utilized in accordance with further embodiments of the system and method of the invention.

An Illustrative Hiring System

Also, a hiring system is disclosed in accordance with yet another embodiment of the invention. The hiring system comprising a user interface portion, the user interface portion accepting input from an applicant accessing the hiring system and displaying output from the hiring system, a processor portion for processing the input accepted by the user interface portion, a memory portion, the processing portion storing input received from the applicant in the memory portion, and a management control portion, the management control portion for managing the applicant's status in the hiring system.

The hiring system further provides for an applicant who accesses the hiring system through the user interface portion, the hiring system activates a first input data entry interface, the hiring system accepts a first input from the applicant using the first input data entry interface, the first input including basic applicant information, the hiring system creates a new applicant data record in the memory portion and stores the first input in the new applicant data record.

The hiring system activates a secondary input data entry interface, the hiring system accepts a secondary input from the applicant using the secondary input data entry interface, the secondary input relating to professional job requirements associated with the professional position applied for. The hiring system stores the secondary input in the new applicant data record, a hiring system administrator utilizes the management control portion to review the new applicant data record, the new applicant data record including the first input and the secondary input submitted by the applicant.

The hiring system administrator determines that the applicant satisfies the professional job requirements necessary for hiring, the hiring system administrator utilizes the management control portion to give the applicant an offer for the professional position applied for, the hiring system receives acceptance input from the applicant of the offer for the professional position applied for and stores the acceptance input in the new applicant data record, and the hiring system submits the new applicant data record to an employee staffing system for assignment of the applicant to the professional position applied for, for example.

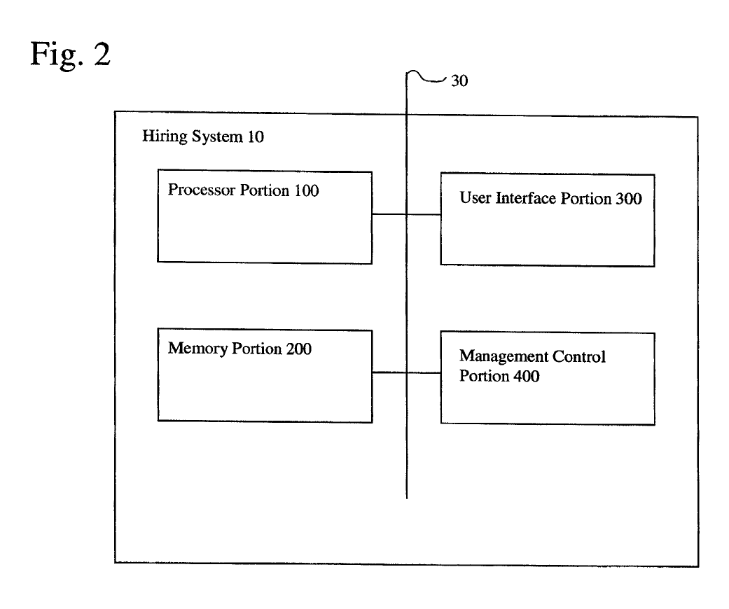

FIG. 2 is a block diagram showing a hiring system 10 in accordance with one embodiment of the system and method of the invention. As shown in FIG. 2, the hiring system 10 includes a processor portion 100, a memory portion 200, a user interface portion 300, and a management control portion 400. Each of the processor portion 100, memory portion 200, user interface portion 300, and management control portion 400 are connected to and in communication with each other through a data bus 30. However, it should of course be appreciated that any suitable communication interface might be utilized to connect the operating components of the hiring system 10.

The components of the hiring system 10, as described above, may be utilized to implement a method of hiring an applicant for a professional position. The processor portion 100 monitors and controls the various operations of the hiring system 10. The memory portion 200 serves as a memory store for a wide variety of data used by the processor portion 100, as well as the other components of the hiring system 10. The user interface portion 300 provides the interface through which the applicant can provide input to the hiring system 10. The management control portion 400 provides the interface between a system administrator and the hiring system 10, through which a system administrator can review the input submitted by the applicant to the hiring system 10. Further details of the components of the hiring system 10 are provided below.

As shown in FIG. 2, the hiring system 10 includes a memory portion 200. The memory portion 200 stores a variety of data utilized in operation of the hiring system 10.

It should be appreciated that the various memory components contained in the memory portion 200 may take on a variety of architectures as is necessary or desired by the particular operating circumstances. Further, the various memory components of the memory portion 200 may exchange data or utilize other memory component data utilizing known techniques such as relational database techniques.

As shown in FIG. 2, the hiring system 10 includes a user interface portion 300. The user interface portion 300 generally provides applicant interaction capabilities. That is, the user interface portion 300 is controlled by the processor portion 100, or components thereof, to interface with an applicant or other operating system including inputting and outputting data or information relating to the hiring system 10.

As shown in FIG. 2, the hiring system 10 includes a management control portion 400. The management control portion 400 provides the interface between a system administrator and the hiring system. A system administrator utilizes the management control portion 400 to manage an applicant's progress in the hiring system 10. This may be accomplished using an illustrative management control portion interface as shown by interface 500 in FIG. 3.

As described above, one embodiment of the processing system of the invention as shown in FIG. 2 is in the form of a computer or computer system. As used herein, the term “computer system” or “operating system” is to be understood to include at least one processor utilizing a memory or memories. The memory stores at least portions of an executable program code at one time or another during operation of the processor. Additionally, the processor executes various instructions included in that executable program code. An executable program code means a program in machine language or other language that is able to run in a particular computer system environment to perform a particular task. The executable program code process data in response to commands by a user. As used herein, it will be appreciated that the term “executable program code” and term “software” mean substantially the same thing for the purposes of the description as used herein.

Further, it is to be appreciated that to practice the system and method of the invention, it is not necessary that the processor, or subportions of the processor, and/or the memory, or subportions of the memory be physically located in the same place or disposed in the same physical portion of the hiring system 10. That is, it should be appreciated that each of the processor and the memory may be located in geographically distinct locations and connected so as to communicate in any suitable manner, such as over a wireless communication path, for example. Additionally, it should be appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, each respective portion of the memory described above may include two or more portions of memory in two or more physical locations. Further, the memory could include or utilize memory stores from the Internet, Intranet, Extranet, LAN or some other source or over some other network, as may be necessary or desired.

As described above, the invention may illustratively be embodied in the form of a computer or computer operating system. It is to be appreciated that the software that enables the computer operating system to perform the operations described above may be supplied on any of a wide variety of data holding media. Further, it should be appreciated that the implementation and operation of the invention may be in the form of computer code written in any suitable programming language, which provide instructions to the computer.

It should further be appreciated that the software code or programming language that is utilized in a computer system to perform the various operations of the above described invention may be provided in any of a wide variety of forms. Illustratively, the software may be provided in the form of machine language, assembly code, object code, or source language, as well as in other forms. Further, the software may be in the form of compressed or encrypted data utilizing an encryption algorithm.

Additionally, it should be appreciated that the particular medium utilized may take on any of a variety of physical forms. Illustratively, the medium may be in the form of a compact disk, a DVD, an integrated circuit, a hard disk, a floppy diskette, a magnetic tape, a RAM, a ROM, or a remote transmission, as well as any other medium or source of information that may be read by a computer or other operating system.

Accordingly, the software of the method of the invention, which is utilized in operation of the hiring system 10, may be provided in the form of a hard disk or be transmitted in some form using a direct wireless telephone connection, the Internet, an Intranet, or a satellite transmission, for example. Further, the programming language enabling the system and method of the invention as described above may be utilized on all of the foregoing and any other medium by which software or executable program code may be communicated to and utilized by a computer or other operating system.

As described herein, the system and method of the invention may utilize an application program, a collection of separate application programs, a module of a program that is designed to handle, or a portion of a module of a program, for example. As noted above, it should be appreciated that the computer language used in the system and method of the invention may be any of a wide variety of programming languages. Further, it is not necessary that a single programming language be utilized in conjunction with the operation of the system and method of the invention. Rather, any number of different programming languages may be utilized as is necessary or desirable.

As described above, in the system and method of the invention, a variety of user interfaces are utilized. A user interface may be in the form of a dialogue screen for example. As used herein, a user interface includes any software, hardware or combination of hardware and software used in an operating system that allows a user to interact with the operating system. A user interface may include any of a touch screen, keyboard, mouse, voice reader, voice recognizer, dialogue screen, menu box, a list, a checkbox, a toggle switch, a pushbutton or any other object that allows a user to receive information regarding the operation of the program and/or provide the operating system with information. Accordingly, the user interface is any device that provides communication between a user and a computer. The information provided by the user to the computer through the user interface may be in the form of a command, a selection or data, or other input, for example.

A user interface is utilized by an operating system running an application program to process data for a user. As should be appreciated, a user interface is typically used by a computer for interacting with a user either to convey information or receive information. However, it should be appreciated that in accordance with the system and method of the invention, it is not necessary that a human user actually interact with a user interface generated by the operating system of the invention. Rather, it is contemplated that the user interface of the invention interact, i.e., convey and receive information, in communication with another operating system or computer, rather than a human user. Further, it is contemplated that the user interfaces utilized in the system and method of the invention may interact partially with another operating system while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

It is understood that the present invention may be practiced by adding additional steps to the method, omitting steps within the process, and/or altering the order in which the steps are performed in the process.

Accordingly, while the present invention has been described here in detail in relation to its preferred embodiment, it is to be understood that this disclosure is only illustrative and exemplary of the present invention and is made merely for the purposes of providing a full and enabling disclosure of the invention. Many modifications to the embodiments described above can be made without departing from the spirit and scope of the invention. Accordingly, the foregoing disclosure is not intended to be construed or to limit the present invention or otherwise to exclude any other such embodiments, adaptations, variations, modifications and equivalent arrangements.

What is claimed is:

1. A method for hiring an applicant for a professional position, the method comprising the steps of:
providing a hiring system, the hiring system including:
a user interface portion, the user interface portion accepting input from an applicant accessing the hiring system and displaying output generated by the hiring system, the applicant applying for a professional position;
a processor portion for processing the input accepted by the user interface portion;
a memory portion, the processing portion storing input accepted from the applicant in the memory portion; and
a management control portion, the management control portion for managing the applicant's status in the hiring system;
accessing the hiring system by the applicant;
activating by the hiring system a first input data entry interface;
accepting by the hiring system a first input from the applicant using the first input data entry interface, the first input including basic applicant information;
creating by the hiring system a new applicant data record in the memory portion and storing the first input in the new applicant data record;
activating by the hiring system a secondary input data entry interface;
accepting by the hiring system at least one required secondary input from the applicant using the secondary input data entry interface, the at least one required secondary input relating to professional job requirements associated with the professional position applied for;
storing by the hiring system the at least one required secondary input in the new applicant data record;
utilizing by a hiring system administrator the management control portion to review the new applicant data record, the new applicant data record including the first input and the at least one required secondary input submitted by the applicant;
determining by the hiring system administrator that the applicant satisfies the professional job requirements necessary for hiring;
utilizing by the hiring system administrator the management control portion to give the applicant an offer for the professional position applied for;
accepting by the hiring system acceptance input from the applicant of the offer for the professional position applied for and storing the acceptance input in the new applicant data record; and
submitting by the hiring system the new applicant data record to an employee staffing system for assignment of the applicant to the professional position applied for.

2. The method of claim 1, wherein the first input includes a professional position selection indicating the professional position that the applicant is applying for.

3. The method of claim 2, wherein the first input further includes a specialty selection indicating a specialty within the professional position that the applicant is applying for.

4. The method of claim 3, wherein the first input further includes an employment location selection indicating a desired location for the professional position that the applicant is applying for.

5. The method of claim 4, wherein the at least one required secondary input includes professional license information.

6. The method of claim 5, wherein the hiring system administrator begins verifying the professional license information upon receipt of the professional license information.

7. The method of claim 4, wherein the at least one required secondary input includes professional reference information.

8. The method of claim 7, wherein the hiring system administrator begins verifying the professional reference information upon receipt of the professional reference information.

9. The method of claim 4, wherein the secondary data input interface includes supplemental questions associated with the professional position selection, the specialty selection and the employment location selection.

10. The method of claim 4, wherein the secondary data input interface includes a mandatory test having test questions associated with the professional position selection and the specialty selection, the mandatory test further having an associated passing score equal to a predetermined number of test questions, the applicant being required to correctly answer a passing number of test questions equal to or greater than the associated passing score.

11. The method of claim 1 further including creating an applicant record e-mail account having a unique address such that e-mail correspondence sent from the applicant to the unique address is stored with the new applicant data record.

12. The method of claim 1 wherein the first input includes an applicant e-mail address of record.

13. The method of claim 12, wherein the hiring system administrator sends an e-mail to the applicant e-mail address of record notifying the applicant that the applicant has not submitted at least one required secondary input.

14. A hiring system comprising:
a user interface portion, the user interface portion accepting input from an applicant accessing the hiring system and displaying output from the hiring system;
a processor portion for processing the input accepted by the user interface portion;
a memory portion, the processing portion storing input received from the applicant in the memory portion;
a management control portion, the management control portion for managing the applicant's status in the hiring system;
wherein:
an applicant accesses the hiring system through the user interface portion;
the hiring system activates a first input data entry interface;
the hiring system accepts a first input from the applicant using the first input data entry interface, the first input including basic applicant information;
the hiring system creates a new applicant data record in the memory portion and stores the first input in the new applicant data record;
the hiring system activates a secondary input data entry interface;
the hiring system accepts a secondary input from the applicant using the secondary input data entry interface, the secondary input relating to professional job requirements associated with the professional position applied for;
the hiring system stores the secondary input in the new applicant data record;
a hiring system administrator utilizes the management control portion to review the new applicant data record, the new applicant data record including the first input and the secondary input submitted by the applicant;
the hiring system administrator determines that the applicant satisfies the professional job requirements necessary for hiring;
the hiring system administrator utilizes the management control portion to give the applicant an offer for the professional position applied for;
the hiring system receives acceptance input from the applicant of the offer for the professional position applied for and stores the acceptance input in the new applicant data record; and
the hiring system submits the new applicant data record to an employee staffing system for assignment of the applicant to the professional position applied for.

15. A method for hiring an applicant for a professional position, the method comprising the steps of:
providing a hiring system, the hiring system including:
an applicant interface portion, the applicant interface portion having a first input data entry interface and at least one secondary data entry interface, the applicant interface portion accepting input from an applicant accessing the hiring system and displaying output generated by the hiring system to the applicant, the applicant applying for a professional position;
a processor portion for processing the input accepted by the user interface portion;
a memory portion, the processing portion storing input accepted from the applicant in the memory portion; and
a management control portion, the management control portion having a management control interface, the management control portion for managing the applicant's status in the hiring system;
accessing the hiring system by the applicant;
activating by the hiring system the first input data entry interface;
accepting by the hiring system a first input from the applicant using the first input data entry interface;
creating by the hiring system a new applicant data record in the memory portion and storing the first input in the new applicant data record;
activating by the hiring system the at least one secondary input data entry interface;
accepting by the hiring system at least one required secondary input from the applicant using the at least one secondary input data entry interface, the at least one required secondary input relating to professional job requirements associated with the professional position the applicant is applying for;
storing by the hiring system the at least one required secondary input in the new applicant data record;
utilizing by a hiring system administrator the management control interface to review the new applicant data record, the new applicant data record including the first input and the at least one required secondary input submitted by the applicant;
determining by the hiring system administrator that the applicant satisfies the professional job requirements necessary for hiring;
utilizing by the hiring system administrator the management control interface to give the applicant an offer for the professional position applied for;
accepting by the hiring system acceptance input from the applicant of the offer for the professional position applied for and storing the acceptance input in the new applicant data record; and
submitting by the hiring system the new applicant data record to an employee staffing system for assignment of the applicant to the professional position applied for.

16. The method of claim 15 further including creating an applicant record e-mail account having a unique address such that e-mail correspondence sent from the applicant to the unique address is received by the hiring system administrator utilizing the management control interface.

17. The method of claim 16 wherein the hiring system administrator utilizes the management control interface to maintain a log of applicant events.

18. The method of claim 17 wherein the log of applicant events includes at least one of an e-mail from the hiring system administrator to the applicant, an e-mail from the applicant to the applicant record e-mail account having a unique address, a telephone communication from the applicant to the hiring system administrator, a telephone communication from the hiring system administrator to the applicant, a voicemail communication from the applicant to the hiring system administrator, a voicemail communication from the hiring system administrator to the applicant, an offer for the professional position applied for from the hiring system administrator to the applicant, and an acceptance of the offer for the professional position applied for from the applicant.
